(19) United States
(12) Patent Application Publication
(10) Pub. No.: US 2010/0125780 A1
(43) Pub. Date: May 20, 2010

(54) ELECTRONIC DEVICE WITH ANNOTATION FUNCTION AND METHOD THEREOF

(75) Inventors: CHUAN-HONG WANG, Tu-Cheng (TW); HSIAO-CHUNG CHOU, Tu-Cheng (TW); LI-ZHANG HUANG, Tu-Cheng (TW); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/434,682

(22) Filed: May 3, 2009

(30) Foreign Application Priority Data
Nov. 20, 2008 (CN) 200810305667.7

(51) Int. Cl. G06F 17/00

(52) U.S. Cl. 715/232; 715/233; 715/230; 715/227

(57) ABSTRACT

An electronic device with annotation function and a method thereof are provided. The method includes steps of: reading a to-be-displayed original photo; receiving touch operations on a touch screen; generating an annotation interface on the original photo in response to the touch operations, identifying an annotations corresponding to the touch operations, and displaying the annotations on the annotation interface; making the annotations overlaying on the original photo; displaying the overlaid photo; generating a parameter file which includes parameters corresponding to the annotations on the annotation interface; storing the generated parameter file; establishing a relationship between the original photo and the parameter file.

### BACKGROUND

1. Technical Field

The present disclosure relates to an electronic device capable of annotating photos and a method thereof.

2. Description of Related Art

In the past people would make notes on the back of photographs to preserve their memories. Now, however, with the introduction of digital photos and digital photo frames (DPF's), there is no convenient way to do this.

Therefore, what is needed is an electronic device capable of annotating photos and a method thereof.

### BRIEF DESCRIPTION OF THE DRAWINGS

FIG. 1 is a block diagram of the hardware infrastructure of a electronic device in accordance with an exemplary embodiment.

FIG. 2 is a schematic diagrams in accordance with one embodiment.

FIG. 3 is a flowchart of a photo annotation method implemented by the electronic device 10 of FIG. 1, in accordance with an exemplary embodiment.

FIG. 4 is a flowchart of a photo displaying method implemented by the electronic device 10 of FIG. 1, in accordance with an exemplary embodiment.

### DETAILED DESCRIPTION

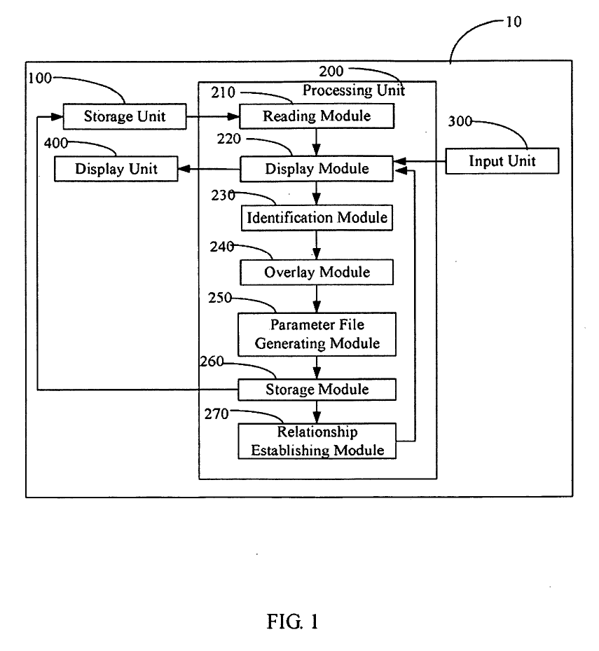

FIG. 1 is a block diagram of the hardware infrastructure of an electronic device in accordance with an exemplary embodiment. The electronic device 10 includes a storage unit 100, a processing unit 200, an input unit 300, and a display unit 400. The storage unit 100 is configured to store photos. The display unit 400 is configured to display the photos. In the exemplary embodiment, the display unit 400 is a touch screen. The input unit 300 is configured to receive touch operations on the display unit 400, for example, when a user touches the screen with a finger or stylus.

The processing unit 200 includes a reading module 210, a display module 220, an identification module 230, an overlay module 240, an parameter file generating module 250, a storage module 260, and a relationship establishing module 270.

The reading module 210 is configured to read a to-be-displayed original photo from the storage unit 100.

The identification module 230 is configured to generate an annotation interface on the original photo in response to the touch operations from the input unit 300, identify an annotation corresponding to the touch operations, and display the annotation on the annotation interface. In the exemplary embodiment, the annotation interface can be used to input text, drawings etc. The annotation interface can be pre-programmed to open as a window of a default size overlaying a portion of the image to be annotated. Then the annotation interface can be expanded or shrank to fit the annotations entered by the user. In addition, the position of the annotation interface in the original photo can be changed by the user, using for example a sliding touch on an edge of the annotation interface to drag the annotation interface to a desired position overlaying the image. Furthermore, the touch screen 400 employs an OCR (Optical Character Recognition) technology to identify the annotations on the annotation interface. However it should be noted that, in other exemplary embodiments, the touch screen 400 could also use some other technology to identify the annotations on the annotation interface.

The overlay module 240 is configured to make the annotation interface becoming transparent leaving only the annotations overlaying the image, or attractively design the annotation interface overlaying on the image along with the annotations to provide a contrasting background for the annotations.

The display module 220 is configured to display the read original photo and overlaid photos on the display unit 400.

The parameter file generating module 250 is configured to generate a parameter file. The parameter file includes parameters of the annotations on the annotation interface. The parameters can be, but are not limited to, annotation position, annotation content, and so on.

The storage module 260 is configured to store the generated parameter file in the storage unit 100.

The relationship establishing module 270 is configured to establish a relationship between the original photo with the generated parameter file. In the exemplary embodiment, when the user views an original photo, the display module 220 detects whether the original photo has an associated parameter file. If the original photo has an associated parameter file, the display module 220 will pop up a window to prompt the user to choose whether to overlay the photo with annotations. If the user chooses yes, the display module 220 overlays the photo on the display unit 400 with the annotations. If the user chooses no, or the original photo does not have an associated parameter file, the display module 220 just displays the original photo on the display unit 400.

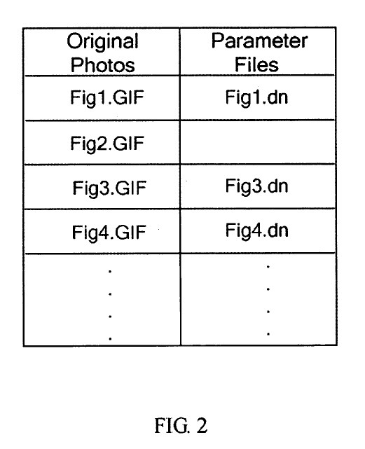

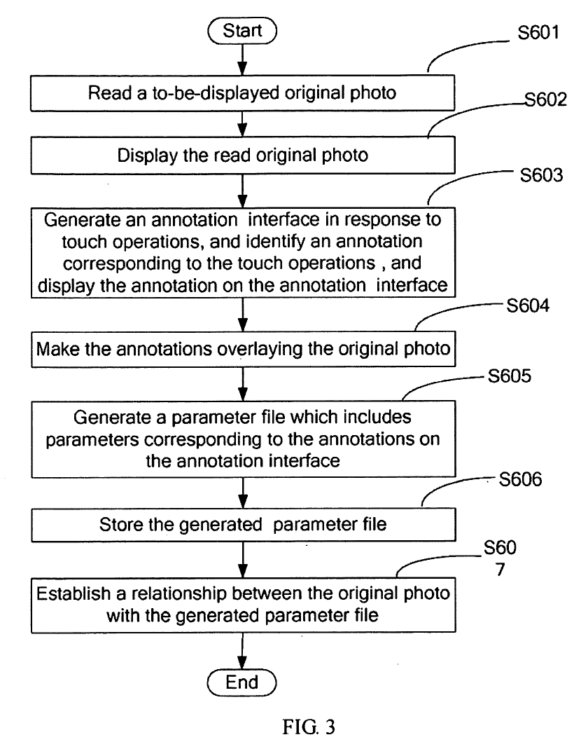

In the exemplary embodiment, the relationship establishing module 270 establishes the relationship between the original photo and the parameter file in a table such as that shown in FIG. 2. For example, in the table, FIG. 1.GIF, FIG. 2.GIF, FIG. 3.GIF . . . are defined as the original photos, and FIG. 1.dn, FIG. 2.dn, FIG. 3.dn, . . . are defined as the parameter files corresponding the original photos. Thereafter, if the parameter file generating module 250 generates a new parameter file, the relationship establishing module 270 will add a new relationship between the corresponding original photo and the new generated parameter file in the table. Accordingly, when the user views an original photo, the display module 220 can search the table to detect whether the original photo has an associated parameter file.

In another exemplary embodiment, instead of using a table, the relationship establishing module 270 can record the relationship between the original photo and the parameter file in the metadata of the original photo. For example, the relationship establishing module 270 records a name of the parameter file in the metadata of the original photo. Thereafter, if the parameter file generating module 250 generates a new parameter file, the relationship establishing module 270 records a name of the new parameter file in the metadata of the original photo to establish the relationship. Accordingly, when the user views an original photo, the display module 220 obtains the metadata of the original photo to detect whether the original photo has an associated parameter file.

FIG. 3 is a flowchart of a photo annotation method implemented by the electronic device 10 of FIG. 1 in accordance with an exemplary embodiment.

In step S601, the reading module 210 reads a to-be-displayed original photo from the storage unit 100.

In step S602, the display module 220 displays the read original photo on the display unit 400.

In step S603, the identification module 230 generates an annotation interface on the original photo in response to the touch operations from the input unit 300, identifies an annotation corresponding to the touch operations, and displays the annotation on the annotation interface.

In step S604, the overlay module 240 makes the annotation interface becoming transparent leaving only the annotations overlaying the image, or attractively designs the annotation interface overlaying on the image along with the annotations to provide a contrasting background for the annotations.

In step S605, the parameter file generating module 250 generates a parameter file which includes parameters corresponding to the annotations on the annotation interface.

In step S606, the storage module 260 stores the generated parameter file in the storage unit 100.

In step S607, The relationship establishing module 270 establishes a relationship between the original photo with the generated parameter file. In first exemplary embodiment, the relationship establishing module 270 establishes the relationship in a table. In second exemplary embodiment, the relationship establishing module 270 establishes the relationship in the metadata of the original photo.

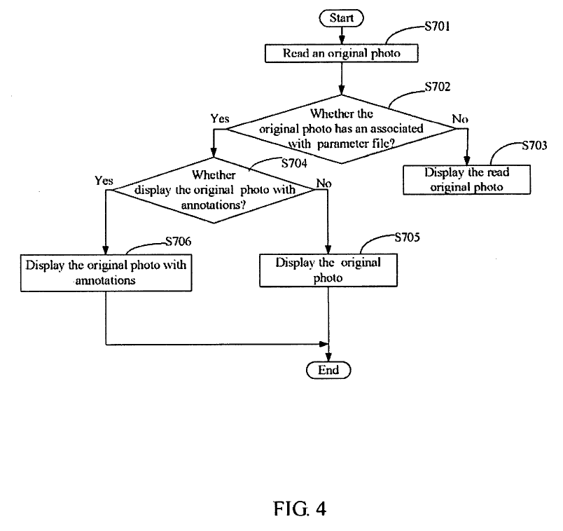

FIG. 4 is a flowchart of a photo displaying method implemented by the electronic device 10 of FIG. 1 in accordance with an exemplary embodiment.

In step S701, the reading module 210 reads a to-be-displayed original photo.

In step S702, the display module 220 detects whether the original photo has an associated with parameter file.

If the original photo does not have an associated with parameter file, in step S703, the display module 220 will directly display the read original photo on the display unit 400.

If the original photo has an associated with parameter file, in step S704, the display module 220 will pop up a window to prompt the user to choose whether overlay the original photo with annotations

In step S705, the display module 220 directly displays the read original photo if the user chooses no.

In step S706, the display module 270 displays an original photo with annotations if the user chooses yes.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with annotation function, comprising:
a storage unit;
an input unit;
a display unit capable for displaying photos, wherein the display unit is a touch screen;
a processing unit comprising:
a reading module capable of reading a to-be-displayed original photo from the storage unit;
an identification module capable of generating an annotation interface on the original photo in response to touch operations from the input unit, identifying an annotation corresponding to the touch operations, and displaying the annotation on the annotation interface;
an overlay module capable of making the annotations overlaying on the original photo;
a display module capable of displaying the read original photo and overlaid photo on the display unit;
an parameter file generating module capable of generating a parameter file which includes parameters of the annotations on the annotation interface;
a storage module capable of storing the generated parameter file in the storage unit;
a relationship establishing module capable of establishing a relationship between the original photo and the parameter file; and wherein the display module displays an original photo with annotations if the original photo has an associated with parameter file.

2. The electronic device as in claim 1, wherein the annotation interface can be used to input text, drawings, or a combination of text and drawings.

3. The electronic device as in claim 1, wherein the position of the annotation interface in the original photo can be changed by the user.

4. The electronic device as in claim 1, wherein the overlay module is capable of making the annotation interface becoming transparent leaving only the annotations overlaying the image.

5. The electronic device as in claim 1, wherein the overlay module is capable of designing the annotation interface overlaying on the image along with the annotations to provide a contrasting background for the annotations.

6. The electronic device as in claim 1, wherein the relationship establishing module is capable of establishing a relationship between the original photo and the parameter file in a table.

7. The electronic device as in claim 1, wherein the relationship establishing module is capable of establishing a relationship between the original photo and the parameter file in a metadata of the original photo.

8. A method for annotating photos, comprising:
reading a to-be-displayed original photo;
receiving touch operations on a touch screen;
generating an annotation interface on the original photo in response to the touch operations, identifying an annotations corresponding to the touch operations, and displaying the annotations on the annotation interface;
making the annotations overlaying on the original photo;
displaying the overlaid photo;
generating a parameter file which includes parameters corresponding to the annotations on the annotation interface;
storing the generated parameter file;
establishing a relationship between the original photo and the parameter file, and displaying an original photo with annotations if the original photo has an associated with parameter file.

9. The method as described in claim 8, wherein the annotation interface can be used to input text, drawings, or a combination of text and drawings.

10. The method as described in claim 8, wherein the position of the annotation interface in the original photo can be changed by the user.

11. The method as described in claim 8, wherein the overlaying step further comprising:
making the annotation interface becoming transparent leaving only the annotations overlaying the image.

12. The method as described in claim 8, wherein the overlaying step further comprising:
designing the annotation interface overlaying on the image along with the annotations to provide a contrasting background for the annotations.

13. The method as described in claim 8, wherein the establishing step further composing:
establishing a relationship between the original photo and the parameter file in a table.

14. The method as described in claim 8, wherein the establishing step further composing:
establishing a relationship between the original photo and the parameter file in a metadata of the original photo.
